(19) United States
(12) Patent Application Publication
(10) Pub. No.: US 2011/0209978 A1
(43) Pub. Date: Sep. 1, 2011

(54) MOLECULAR DISSOCIATION APPARATUS AND METHOD

(76) Inventor: James Leichner, The Villages, FL (US)

(21) Appl. No.: 12/715,304

(22) Filed: Mar. 1, 2010

(51) Int. Cl. B03C 1/23; B01J 19/08

(52) U.S. Cl. 204/155; 422/186.03

(57) ABSTRACT

A molecular dissociation apparatus and method for the dissociation of target molecules into two or more different molecules, atoms, ions, and/or radicals by alternately constructively or destructively interfering with the target molecule's frequency of vibration until its threshold frequency is reached. According to the present invention, there is provided a molecular dissociation apparatus comprising a reaction chamber comprised of a reaction vessel having a reaction space; sensing means operably connected to the reaction chamber; an oscillating electrical source; an oscillating magnetic field generating assembly for imparting an electromagnetic, usually infrared frequency, pulse to a target molecule within the reaction space; an optional photon pulse emission system; and a controller operably connected to all other components for controlling operational parameters.

### FIELD OF THE INVENTION

The subject invention is directed to a method and apparatus for the dissociation of molecules into two or more other molecules, atoms, ions, or radicals. The subject invention can dissociate any molecule, regardless of the complexity of its molecular structure.

### BACKGROUND OF THE INVENTION

Each type of molecule has its own unique “signature” that is different from that of any other type of molecule. Some of the properties that make up a molecular signature are: molecular energies, bonding forces; frequencies, vibrations, oscillations; atomic densities; angular momentum and direction; wavelengths, direction and functions; and molecular spin. The subject invention exploits a molecule's unique vibration frequency to alternately nullify or amplify the electromagnetic force that holds its atoms together (as well as the charged particles of the atoms themselves) causing dissociation into two or more other molecules, atoms, ions, or radicals (hereinafter “reaction products”).

The term “molecule” as used herein is to be interpreted very liberally to mean not only an electrically neutral group of at least two atoms in a definite arrangement held together by very strong (covalent) chemical bonds, but also polyatomic ions, charged organic molecules and biomolecules, any gaseous particle regardless of its composition, atoms and complexes connected by non-covalent bonds such as hydrogen bonds or ionic bonds, ionic crystals (salts) and covalent crystals (network solids) often composed of repeating unit cells, other repeated unit-cellular-structures such as most condensed phases with metallic bonding, and atoms held together by chemical bonds without any definable molecule such as glasses (solids that exist in a vitreous disordered state). Moreover, unless the context suggests otherwise, references to “molecule”, “target molecule”, “molecular”, and the like do not refer to a single molecule, but rather to a single type of molecule to be dissociated. A target molecule may be in solid, liquid or gas phase.

A molecular vibration occurs when atoms in a molecule are in periodic motion while the molecule as a whole has constant translational and rotational motion. The frequency of the periodic motion is known as a vibration frequency which occurs in the Terahertz range and corresponds to the mid-infrared region of the spectrum (30 to 120 THz). This region is also referred to as the “fingerprint” region of the EM spectrum because the mid-infrared absorption spectrum of a compound is very specific for that compound. A nonlinear molecule with n atoms has 3n-6 normal modes of vibration, whereas a linear molecule has 3n-5 normal modes of vibration. A diatonic molecule has one normal mode of vibration. The normal modes of vibration of polyatomic molecules are independent of each other, each involving simultaneous vibrations of different parts of the molecule. Molecular rotation, incidentally, has a frequency that corresponds to the far-infrared region (300 GHz to 30 THz) of the EM spectrum.

The “ground state” or “fundamental vibration” of a molecule is its lowest-energy state. A fundamental vibration is “excited” when a quantum of energy is absorbed by the molecule in its ground state transitioning it to a state with greater energy; an “overtone”. More specifically, a molecular vibration is excited when the molecule absorbs a quantum of energy, E, corresponding to the vibration's frequency, v, according to the relation E=hv, where h is Planck's constant. An excited state, therefore, is any state with energy greater than the ground state. When a second quantum of energy is absorbed the first overtone is excited, and so on to higher overtones. Excitation of the higher overtones involves progressively less and less additional energy and eventually leads to dissociation of the molecule. Vibrational transitions typically require an amount of energy that corresponds to the near-infrared region of the EM spectrum (120 to 400 THz).

Resonance is the tendency of a system to oscillate at larger amplitude at some frequencies than at others. These are known as the system's resonant frequencies (or resonance frequencies). At these frequencies, even small periodic driving forces can produce large amplitude oscillations. In the context of molecular resonance, a molecule will tend to absorb more energy when the frequency of oscillations matches the molecule's natural frequency of vibration (its resonance frequency) than it does at other frequencies.

For the purpose of this document, the energy state where the molecule to be dissociated (the “target molecule”) can no longer sustain itself (hold itself together) is referred to as the “threshold frequency” or alternately, the “threshold energy”, of the molecule. It should be appreciated at the outset that molecular dissociation will result when the threshold energy is either too high (too excited) or too low (too dampened) to hold the molecule together. In accordance with the teachings of the subject invention, this is accomplished through constructive or destructive interference with the resonant frequency of the target, respectively.

### SUMMARY OF THE INVENTION

The subject invention relates to a method and apparatus for the dissociation of target molecules into two or more different molecules, atoms, ions, and/or radicals by constructively or destructively interfering with its frequency of vibration until the target molecule's threshold frequency is reached. According to the present invention, there is provided a molecular dissociation apparatus comprising a reaction chamber comprised of a reaction vessel having a reaction space; sensing means operably associated with the reaction chamber; an oscillating electrical source; an oscillating magnetic field generating assembly for imparting an electromagnetic, usually infrared frequency, pulse to a target molecule within the reaction space; electromagnet orientation adjustment means operably connected to the oscillating magnetic field generating assembly; an optional photon pulse emission system; and a controller operably connected to all other components for controlling operational parameters. The required perturbing frequency delivered by the oscillating electrical source is dependent upon the resonance frequency of the molecule. The perturbing frequency will have the same or nearly the same frequency as the target molecule's resonance frequency. The perturbing frequency is selectively delivered either in phase or out-of-phase with the target molecule's resonant frequency. When the perturbing frequency is delivered in phase (or near in phase) the electromagnetic field exerts an electromagnetic force on the target molecule that increases the wave amplitude of the electromagnetic force that binds the atoms of the molecule together until the molecule reaches its high energy threshold and dissociates (“constructive interference”). Conversely, when the perturbing frequency is delivered out-of-phase (or near out-of-phase) the electromagnetic field exerts an electromagnetic force on the target molecule that decreases the wave amplitude of the electromagnetic force that binds the atoms of the molecule together until the molecule reaches its low energy threshold and dissociates (“destructive interference”). Means for reorienting the angular direction and for adjusting the angular momentum of the targeted molecule are also provided to improve efficiency. By exerting a strong constant magnetic force (in addition to the above oscillating magnetic force), the target molecule's axes are stabilized from a three-dimensional vector to a two-dimensional vector, whereby the oscillating pulse magnetic forces are more effective in dissociating the targeted molecule. Furthermore, the EM bar pairs are also capable of moving their axis for proper molecular alignment. These properties can vary as the dissociation process continues due to the changes in the target molecule's energy.

The theoretical basis for the out-of-phase embodiment of the subject method and apparatus considers that when a perturbing frequency is 180° out-of-phase of the target molecule's resonance frequency, its energy will decrease. As the energy of the molecule decreases, the distance (r) between its atoms increases. As the distance between the atoms increases and the molecule approaches its low energy threshold frequency, the atoms become less interactive with one another. Once the molecular threshold frequency is crossed, the atoms no longer will interact with each other and the molecule will dissociate.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide molecular dissociation apparatus that operates by constructively or destructively interfering with the target molecule's frequency of vibration such that the target molecule's energy becomes either too high or too low, respectively, to maintain atomic bonds.

It is another primary object of the subject invention to provide a molecular dissociation apparatus and method that alternately exaggerate or diminish the electromagnetic force that hold its atoms together until they dissociate from one another.

Another object of the subject invention is to provide a molecular dissociation apparatus and method capable of causing the dissociation of any molecule, regardless of the complexity of its molecular structure.

Still another object of the subject invention is to provide a molecular dissociation apparatus and method designed to break apart molecules efficiently, inexpensively, and without causing harmful pollutants.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a context level component diagram of the molecular dissociation apparatus of the subject invention;

FIG. 2 is a schematical side view of the molecular dissociation apparatus of the subject invention;

FIG. 3 is a schematical cross-sectional view of the apparatus taken along line A-A of FIG. 2;

FIG. 4 is a schematical side view of a first embodiment of a reaction vessel of the subject apparatus;

FIG. 5 is a schematical side view of an alternate embodiment of a reaction vessel of the subject apparatus;

FIG. 6 is a schematic drawing of a pair of electromagnets of the subject apparatus producing repelling magnetic fields when current flows in the same direction through each electromagnet;

FIG. 7 is a schematic drawing of the electromagnets of FIG. 6 producing repelling magnetic fields when the direction of current flowing through a first electromagnet is opposite that flowing through the second electromagnet;

FIG. 8 is a schematic drawing of a pair of electromagnets adjusted in orientation relative to one another causing a change in magnetic field lines;

FIG. 9 is a schematic illustration of an oscillation cycle of an EM pair wherein one of the electromagnets undergoes a polarity shift;

FIG. 10 is a schematic illustration of the effects of a perturbing frequency delivered in-phase with a target molecule's resonant frequency of vibration;

FIG. 11 is a schematic illustration of the effects of a perturbing frequency delivered out-of-phase with a target molecule's resonant frequency of vibration;

FIG. 12 is a schematic illustration of a CO₂ molecule's three modes of vibration;

FIG. 13 is a schematic drawing of a CO₂ molecule exposed to constructive interference via the subject apparatus and method;

FIG. 14 is a schematic drawing of a CO₂ molecule exposed to destructive interference via the subject apparatus and method;

FIG. 15 is a schematic drawing of the subject apparatus enhanced with an optional photon pulse emission system; and

FIG. 16 is a schematic illustration of a pulse shift between the oscillating magnetic field generation assembly and the photon pulse emission system of an alternate embodiment of the subject invention.

### DETAILED DESCRIPTION OF THE PREFERRED EMBODIMENT

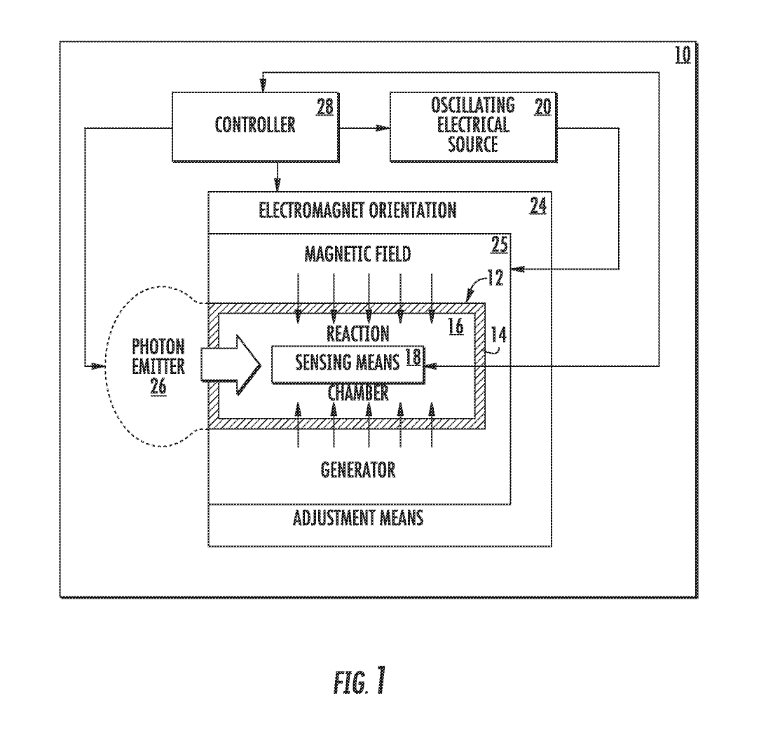

Reference is now made to FIG. 1 in which there is illustrated a context level component diagram of the molecular dissociation apparatus of the subject invention (hereinafter sometimes also referred to as “the subject apparatus”), designated generally by reference numeral 10. In its broadest sense, the subject invention is an apparatus for the dissociation of molecules into two or more other molecules, atoms, ions, or radicals, and is comprised of a reaction chamber 12 comprised of a reaction vessel 14 having a reaction space 16; sensing means 18 operably connected to the reaction chamber; an oscillating electrical source 20; an oscillating magnetic field generating assembly 22 preferably but not essentially external of reaction chamber 12 and operably connected to the oscillating electrical source 20 for imparting an electromagnetic, usually infrared frequency, pulse to a target molecule within reaction space 16; electromagnet orientation adjustment means 24 operably connected to the oscillating magnetic field generating assembly 22; an optional photon pulse emission system 26 in operable communication with reaction space 16; and a controller 28 operably connected to all other components for controlling operational parameters.

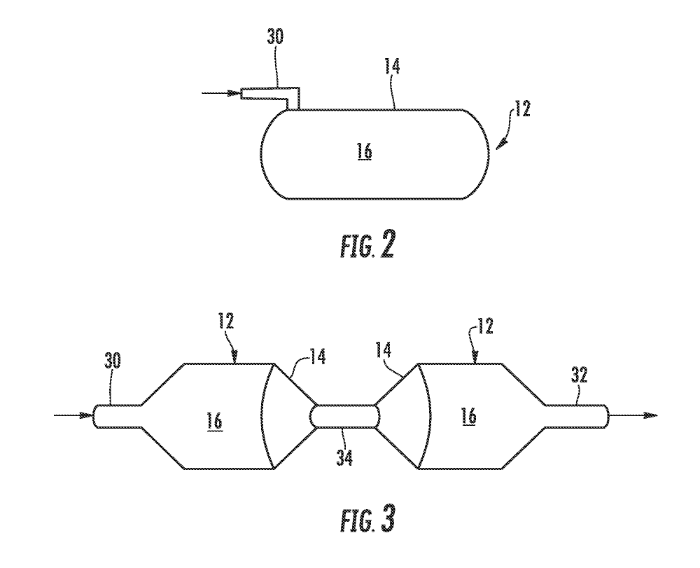

Reaction chamber 12 is suitable for receiving target molecules in gas, liquid, or solid phase (or bound, mixed or otherwise associated with a gas, liquid or solid of other compositions of matter), for dissociation. Referring now to FIGS. 2 and 3, reaction chamber 12 may be either a closed or “static” system, or an open or “dynamic” system, respectively. An inlet 30 is disposed through the wall of reaction vessel 14 for the receipt of the target matter therethrough. Inlet may be in the form of a conduit for fluids or a door for solids, for instance. In the closed system of FIG. 2, reaction chamber 12 may be vacuumed and charged with a target molecule through inlet 30. A sample carrier (not shown) may be disposed in the reaction space (for dissociation of target molecules in solid state or bound by a substrate in solid state). In the open system of FIG. 3, the targeted fluid is introduced into the reaction space 16 via inlet 30 and permitted to flow through the system while acted upon by the oscillating magnetic field generating assembly 22 (not shown in FIGS. 2 and 3) with at least some of the reaction products exiting the system through outlet 32. Other reaction products may be collected within the system for subsequent removal. As may be appreciated, two or more reaction chambers 12 may be connected in series via suitable connectors 34 when complete dissociation of the target molecule is not possible within the timeframe that it passes through a single reaction chamber 12.

The material for constructing the reaction vessel 14 can be magnetic or nonmagnetic. Both types of material are acceptable, however, a nonmagnetic material is preferred because it does not affect the electromagnetic field created by the oscillating magnetic field generating assembly 22 thereby eliminating an unnecessary variable and resulting in a more efficient overall system. Vessel 14, therefore, may be formed of a material selected from glass, ceramics and polymers, for instance. Reaction vessel 14 may be constructed of a plurality of separate parts which are coupled together to define reaction space 16, or may be of unibody construction.

The shape of reaction chamber 12, and the interior of vessel 14, depends on the process at hand. Cylindrical, oval, spherical and polygonal shapes are all contemplated and are selected based on the efficiency with which dissociation of the target molecule occurs is determined through experimentation.

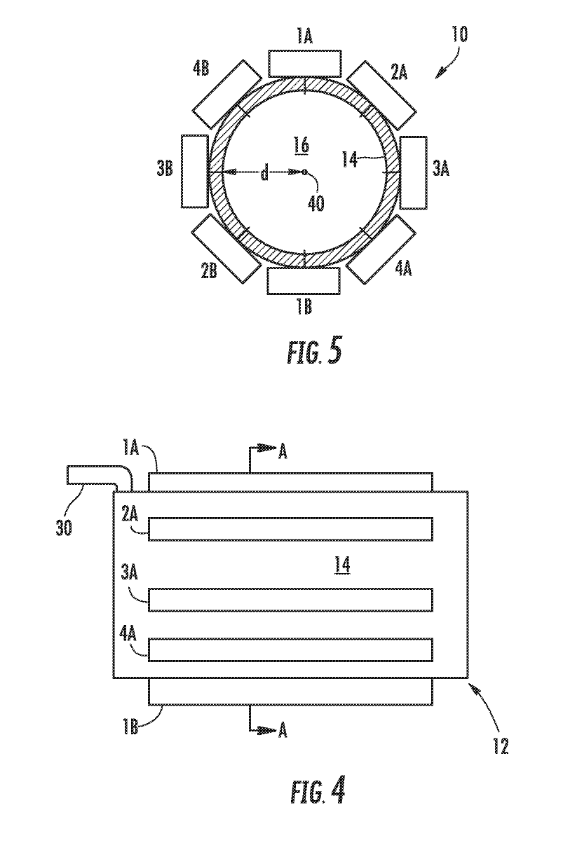

Reference now being made to FIGS. 4 and 5, in at least one embodiment of the subject apparatus, reaction chamber 12 also serves as a support structure for oscillating magnetic field generating assembly 22 and for optional photon pulse emission system 26 described below. The oscillating magnetic field generating assembly 22 is preferably but not essentially disposed outside reaction vessel 14, but may also be located inside reaction vessel 14 or integrated within its walls. Oscillating magnetic field generating assembly 22 may be supported by reaction chamber 12 or by separate framing constructed for this purpose.

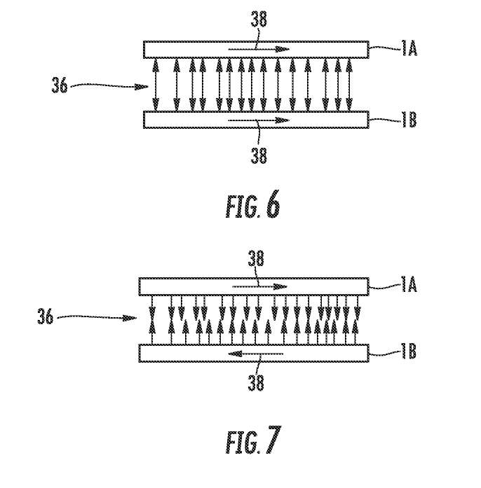

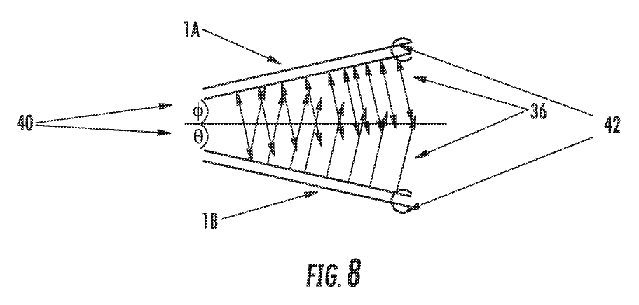

Oscillating magnetic field generating assembly 22 is comprised of at least one pair of electrical coils 1A,1B each of which is operably connected to oscillating electrical source 20. Each pair of coils is arranged such that the magnetic field lines generated by one electrical coil substantially oppose those of the other in the space between them (i.e., in reaction space 16). More specifically, and referring to FIGS. 6 and 7, the lines of force 36 associated with each magnetic field are directional opposites, but are equal in magnitude. Although in actuality the force between two magnets is quite complicated and depends on the orientation of both magnets and the distance of the magnets relative to each other, those skilled in the art can exploit these factors to produce opposing lines of force 36 that are as aligned as possible.

Reorientation of at least one electromagnet may be required in some instances to adjust for a target molecule's molecular direction and/or molecular momentum. Accordingly, means for adjusting the orientation of each electromagnet are also provided (but not shown). Specifically, electromagnet orientation adjustment means 24 are operably connected to controller 28 and may be of a variety of constructions known to those skilled in the art. Electromechanical means are typical. Adjustment means 24 provide for the selectable reorientation of each electromagnet in oscillating magnetic field generating assembly 22, and their corresponding lines of force 36. Referring to FIGS. 1 and 8, Adjustment means 24 cause each electromagnet of EM pair 1A,1B to become offset from their normally parallel axis at angles 40 ranging from 0 to 10 degrees. Rotation about each electromagnet's longitudinal axis up to approximately 5 degrees is also contemplated as indicated by directional arrows 42.

The actual required number of electromagnetic bars employed in the operation of the subject apparatus depends on the process at hand (i.e., on the complexity of the molecule to be dissociated). In a preferred embodiment, all electromagnets that form part of the assembly are normally oriented in parallel relationship with, and incrementally spaced from, one another about the outer perimeter of reaction chamber 12; each being an equal distance d from, and normally parallel to the longitudinal axis 38 of the chamber. In the example illustrated in FIGS. 4 and 5, four electromagnetic pairs 1A,1B; 2A,2B; 3A,3B; and 4A,4B (each an “EM pair”) are employed. It should be appreciated that the specific construction and orientation of each electromagnet is not limited to the description above, the primary criteria being their ability to emit a uniform electromagnetic field within reaction space 16 that simulates that of the target molecule.

Chamber 12 further includes sensing means 18 comprised of sophisticated analytical and monitoring equipment for determining, inter alia, internal, pressures and temperatures, flow rates, magnetic field strengths, atomic and molecular densities, and other physical and chemical properties (together “operational properties”) and means for transmitting this data to controller 28 for processing. Reaction chamber 12 further includes an automatic shutdown system activated whenever sensing means 18 detects that pressures and/or temperatures within reaction chamber 12 exceed predetermined limits.

Controller 28 is operably connected to sensing means 18, to oscillating electric source 20, to oscillating magnetic field generating assembly 22, to electromagnetic orientation adjustment means 24 and to the optional photon pulse emission system 26 for controlling all of the same. More specifically, controller 28 is a computerized system responsible for calculating and setting all operating parameters, receiving, analyzing and storing all data (pre-operation, operation, and post-operation) generated by sensing means 18 and other system components, and for automatically adjusting operational parameters in order to maximize and maintain the efficiency of the overall system. The controller is, for instance, responsible for setting and adjusting the oscillation frequency of oscillating electrical source 20 and for controlling the firing sequence of both oscillating magnetic field generating means 22 and optional photon pulse emission system 26 in a sequential order that dissociates the targeted molecular structures effectively and efficiently.

### Method of Operation

Reaction space 16 is first charged with a target molecule through inlet 30. The resonant frequency of the target molecule is ascertained via sensing means 18 if not already known. Controller 28 causes oscillating electric source 20 to deliver a pulse oscillating (but not necessarily alternating) current of electricity to at least one EM pair of oscillating magnetic field generating assembly 22 at or near the target molecule's resonance frequency. For most molecules, the perturbing frequency corresponds to the mid-infrared region of the spectrum (30 to 120 THz).

Oscillating electric source 20 is programmed to “fire” a pulse through at least one EM pair. The terms “fire”, “firing”, “fires” and other variations are interchangeable and refer to creating an electrical current through an electromagnet, producing a magnetic field. When firing an EM pair, it is critical that both electromagnets fire simultaneously. When the current is oscillated in pulsed fashion the electromagnet emits an electromagnetic field. Here again, it is critical that both electromagnets in an EM pair produce their magnetic fields at the same frequency of oscillation. To produce one complete cycle, two pulses must occur. A minimum of one complete cycle must occur each time.

The subject method of dissociating a target molecule may be carried out by employing at least one of six primary modes of operation of apparatus 10. These modes depend on two variables; current direction and oscillation phase. With regard to the first variable, depending on the direction of current (indicated by directional arrows 38 of FIGS. 6 and 7) produced by oscillating electrical source 20 through each electromagnet 1A,1B, the electromagnets will generate repelling (FIG. 6) or attracting (FIG. 7) electromagnetic fields. For example, when the direction of current through each electromagnet 1A,1B is the same, as illustrated in FIG. 6, the resulting EM fields will possess repelling lines of force 36. Objects (i.e., a target molecule) located between an EM pair with repelling lines of force encounter a pulling or “stretching” force. A complete cycle therefore involves the exertion of a “pull-pull” electromagnetic force on the target molecule. When the direction of current through each electromagnet 1A,1B is opposite, as illustrated in FIG. 7, the resulting EM fields will possess attracting lines of force 36. Objects located between an EM pair with attracting lines of force, encounter a pushing or “compressing” force. A complete cycle therefore involves the exertion of a “push-push” electromagnetic force on the target molecule.

In many cases, the force and the torque on an object between magnets can be modeled quite well by assuming a ‘magnetic charge’ at the poles of each magnet. The term “pole” refers to the magnetic pole, either the south or north magnetic pole that is produced by each electromagnet when fired. The term “polarity” refers to the direction of the current flowing through an electromagnet. The term “polarity shift” refers to a change in the direction of the current. A polarity shift through an electromagnet switches its magnetic pole.

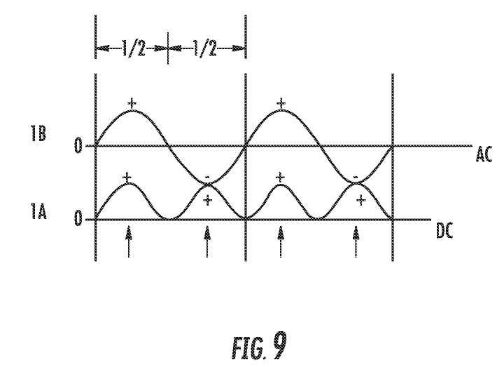

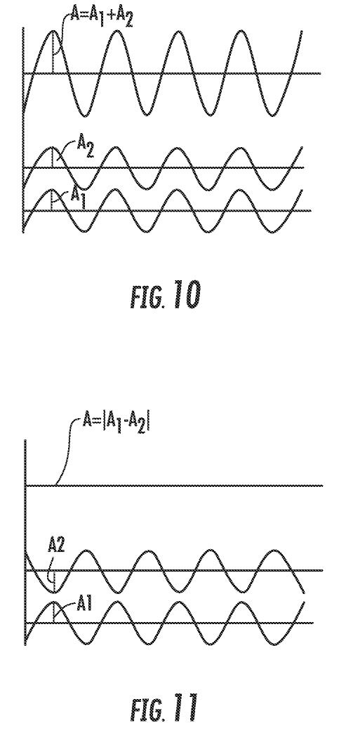

Accordingly, when one of the electromagnets 1A,1B in the above two examples undergoes a polarity shift in the middle of a complete cycle, objects located between the EM pair encounter, alternately, a pushing force and a pulling force, or vice versa. A complete cycle therefore involves the exertion of a “push-pull” (or alternately a “pull-push”) electromagnetic force on the target molecule. This operation is illustrated in FIG. 9 where an EM pair 1A,1B are fired simultaneously in pulse oscillating fashion. As may be observed, the current through first electromagnet 1A maintains direction during each oscillation cycle (a direct current) while the current through electromagnet 1B undergoes a polarity shift every ½ cycle (an alternating current). During the first half of the cycle, the electromagnets have the same polarity and therefore repel one another. During the second half of the cycle, electromagnet 1B undergoes a polarity shift; the electromagnets have opposite polarities and therefore attract one another. If they were not supported, they would collapse together. A target molecule subjected to a complete cycle as illustrated by FIG. 9 would undergo a “pull-push” electromagnetic force.

Each of the three modes of operation: “pull-pull”, “push-push” and alternating “pull-push” (or “push-pull”) will cause dissociation of a target molecule when placed between the electromagnets 1A,1B if the perturbing frequency of oscillation is delivered in-phase (or near in phase) or out-of-phase (or near out-of-phase) with the resonant frequency of the target molecule. It should be appreciated that it is not necessary to have a polarity shift in the magnetic fields to break down the molecular structure as long as the molecular frequencies are matched, however it does increase the efficiency of the system. This means that it takes less time and less energy to accomplish the same required task.

Reference now being made to FIGS. 10 and 11, the effect of the second variable, namely oscillation phase, is described. The perturbing frequency λₚ is selectively delivered by the subject apparatus 10 either in-phase (FIG. 10) or out-of-phase (FIG. 11) with the target molecule's resonant frequency λ_{target}. With specific reference to FIG. 10, when the perturbing frequency λₚ is delivered in-phase (or near in phase) with the target molecule's resonant frequency λ_{target} the electromagnetic field generated by each electromagnet in an EM pair exerts an electromagnetic force on the target molecule that increases the wave amplitude of the electromagnetic force that binds the atoms of the molecule together until the molecule reaches its high energy threshold and dissociates. Thus, for two waves that are in phase, with amplitudes A₁ and A₂, the troughs and peaks line up and the resultant wave will have amplitude A=A₁+A₂. This is referred to as dissociation through “constructive interference”. This reaction method is more disruptive; possibly causing unstable atoms.

Referring to FIG. 11, conversely, when the perturbing frequency λₚ is delivered out-of-phase (or near out-of-phase) with the target molecule's resonant frequency λ_{target}, the electromagnetic field exerts an electromagnetic force on the target molecule that decreases the wave amplitude of the electromagnetic force that binds the atoms of the molecule together until the molecule reaches its low energy threshold and dissociates. Thus, if the two waves are π radians, or 180°, out-of-phase, then one wave's crests will coincide with another wave's troughs and so will tend to cancel out. The resultant amplitude is A=|A₁−A₂|. If A₁=A₂, the resultant amplitude will be zero. This is referred to as dissociation through “destructive interference”. As the molecular amplitude decreases, the energy of the molecular structure also decreases. As the energy of the molecule decreases, the distance between its atoms increases. As the distance between the atoms increases, the molecule approaches its low energy threshold frequency where the atoms become less interactive with one another. Once the molecular threshold frequency is crossed, the atoms no longer will interact with each other and molecule will no longer exist. This is a more gentle and efficient technique in causing dissociation of the target molecule.

Based on the above, it should now be appreciated that the six primary modes of operation are: 1) in-phase push-push; 2) in-phase pull-pull; 3) in-phase alternating push-pull (or pull-push); 4) out-of-phase push-push; 5) out-of-phase pull-pull; and 6) out-of-phase alternating push-pull (or pull-push). Each of these modes may be carried out by at least one EM pair on the target molecule. It should be further appreciated that it is not necessary to cancel out the molecular frequency in order to break down the target molecule into individual atoms, the molecular frequency must just drop below its threshold frequency. This is important because the less energy required to achieve dissociation, the less costly it is to operate the system.

### Example

### Dissociation of Carbon Dioxide (CO₂)

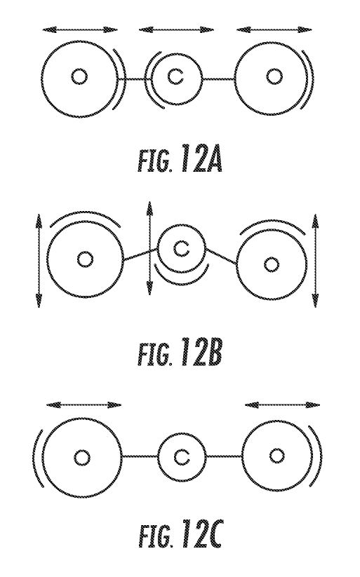

CO₂ is a greenhouse gas that will rapidly become a global killer if humankind does not curtail its emissions. The best scientists in the world absolutely do not know what to do about these emissions. Even though CO₂ is considered a linear molecule and acts much like diatomic molecule, it has an extremely strong bond that holds the molecular structure together and it is very difficult to break up. However, the bond strength of a molecule is of no consequence when its natural frequency of vibration is targeted. CO₂ is a triatomic molecule that has three modes of vibration as illustrated in FIG. 12.

Dissociation of the target molecule CO₂ may be carried out by subjecting at least one of these three modes of vibration to a perturbing frequency of equal value in-phase (or near in-phase) or out-of-phase (or near out-of-phase) with CO₂'s resonant frequency.

### In-Phase Operation

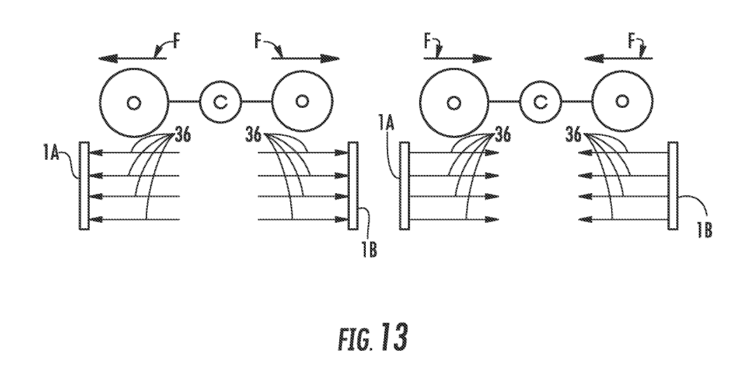

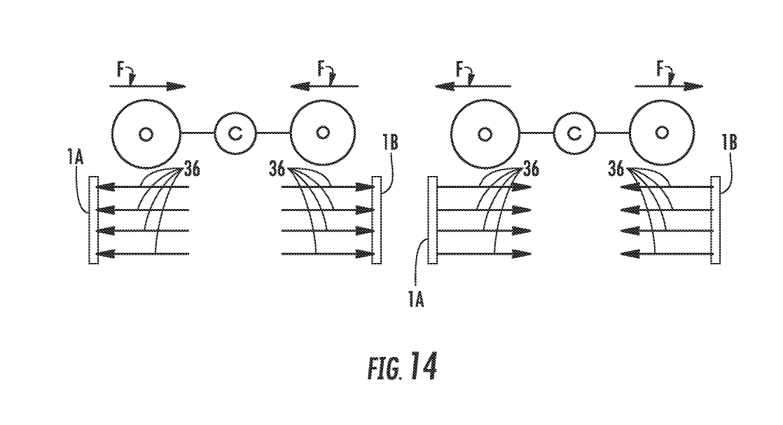

When the perturbing frequency generated by the subject apparatus 10 is in-phase with at least one of the target molecule's three modes of vibration, the external perturbing electromagnetic force and the molecule's internal electromagnetic force are in sync. Referring to the mode 3 illustration of FIG. 13, the oxygen atoms are vibrating back and forth as the carbon atom is relaxed. When the magnetic pulse is in-phase with the two oxygen atoms, it is completely in sync. with the molecular vibration, which means that the forces F are moving in the same direction. As the oxygen atoms are repelling away from the carbon atom (motion is away from the carbon atom), the two magnetic fields are also stretching the molecule. When the oxygen atoms are pulling toward the carbon atom (motion toward the carbon atom), the magnetic field is compressing the molecule. This stretching and compressing of the molecule is what increases the amplitude of the wave function. Stated another way, the energy from the magnetic system is being absorbed into the molecule. If the perturbing frequency and amplitude are identical to the resonance frequency of the target molecule, then the amplitude doubles as does the molecular energy, causing molecular dissociation. In some cases, however, the resulting amplitude may need to be more than doubled or less than doubled for dissociation to occur.

### Out-Of-Phase Operation

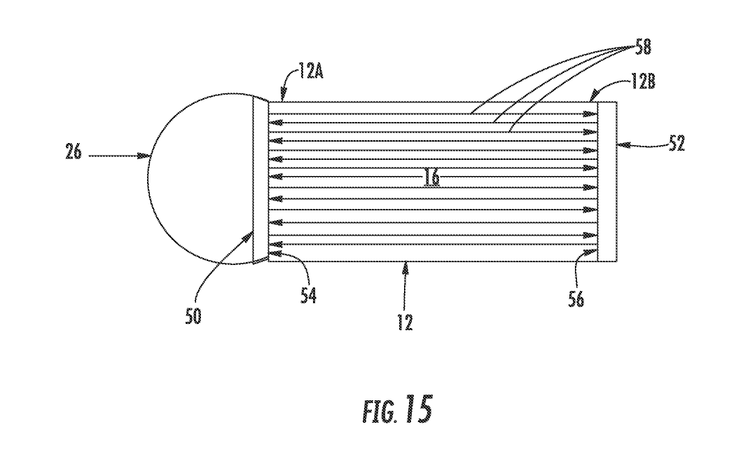

When the perturbing frequency generated by subject apparatus 10 is 180° out-of-phase with at least one of the target molecule's three modes of vibration, the external perturbing electromagnetic force and the molecule's internal electromagnetic force are out of sync. Referring to the mode 3 illustration in FIG. 14, the oxygen atoms are vibrating back and forth as the carbon is relaxed. When the magnetic pulse is out-of-phase with the two oxygen atoms, it is completely out of sync. with the molecular vibration, which means that the forces F are moving in opposite directions. As the oxygen atoms are vibrating inward (motion towards the carbon atom), the force components of the two magnetic fields are stretching the atomic bonds. This means that the perturbing and intermolecular forces are moving in the opposite direction. When the oxygen atoms are vibrating outward (the motion of the oxygen atoms are away from the carbon atom), the magnetic forces F are repelling (pushing) one another, compressing the molecule. When the oxygen atoms are pulling toward the carbon atom (motion toward the carbon atom), the force components of the two magnetic fields F are stretching the atomic bonds. The motion of the two systems (the magnetic and molecular motions) are reduced or completely cancelled.

Each EM pair 1A-4A,1B-4B is independent from each other and has its own channel of operation that is controlled by controller 28. This means that all three modes of vibration for the CO₂ molecule (seven modes for some of the polyatomic molecules) can be separately or simultaneously addressed for both in-phase and out-of-phase molecular vibrations.

Efficiency of the subject molecular dissociation apparatus 10 may be increased through various means. As a first measure, means for imparting a constant (as opposed to pulsating) magnetic field within reaction space 16 may be provided. For purposes of clarity, such means for imparting a constant magnetic field are different from the above described oscillating magnetic field generating means. The imposition of a static magnetic field will tend to stabilize the target molecule's tumbling axis. This will cause the otherwise tumbling target molecule to come into and maintain a common orientation within the reaction space. By stabilizing the target molecule's orientation along a particular predefined axis, the perturbing electromagnetic forces subsequently imparted by the at least one EM pair 1A-4A,1B-4B can selectively amplify or suppress the molecule's amplitude of vibration with greater efficiency. This is because the perturbing oscillating force will come into directional alignment with the targeted electromagnetic force of the molecule with greater frequency when the molecule is “still” rather than randomly changing its orientation. Stabilizing the orientation of a target molecule may also be accomplished by imparting a potential across the reaction space such as may be created between opposing plates of a capacitor.

Another means of increasing the efficiency of molecular dissociation is accomplished by utilizing electromagnet orientation adjustment means 24 to selectively reorient at least one electromagnet in oscillating magnetic field generating assembly 22, thereby altering the vector components of electromagnetic force generated as well as the character of the electromagnetic field in reaction space 16 generally. Sensing means 18 provides feedback data to controller 28 to analyze what change in orientation of the at least one electromagnet causes an increase in the rate of molecular dissociation as measured by detection of the measure of reaction products produced. Based on this feedback the optimal orientation of each electromagnet can be identified. It should be noted that this is a dynamic process as variables continuously change during the reaction process as the target molecule experiences changes in energy state.

Referring once again to FIG. 5, efficiency of molecular dissociation may also be improved by adjusting the firing sequences of EM pairs 1A,1B; 2A,2B; 3A,3B; 4A,4B. The firing sequence is the order in which the EM pairs fire. There are various firing sequences which are based on the complexity of the molecular structure. This is an important and complex aspect of the overall system. The firing sequence could require only one EM pair to fire at a continuous rate. For example, only EM pair 1A,1B fires continuously until the desired level of molecular dissociation has occurred. Alternatively, multiple EM pairs may be fired simultaneously. For example, EM pairs 1A,1B; 2A,2B and 4A,4B are fired simultaneously. Still further, in some instances the electromagnetic fields are required to rotate. This is accomplished by setting firing sequences so that the EM pairs are fired in sequential order. For example, EM pair 1A,1B is caused to fire for a given duration or number of pulses followed immediately by EM pair 2A,2B and so forth and the sequence is then repeated as necessary. Combinations of EM pairs may be fired in sequence as well. In all instances, sensing means 18 provides feedback data to controller 28 to analyze what firing sequence best increases the rate of molecular dissociation for the least amount of energy input into the system to optimize efficiency. Here again, this is a dynamic process as variables continuously change during the reaction process as the target molecule experiences changes in energy state.

### Photon Pulse Emission System Enhancement

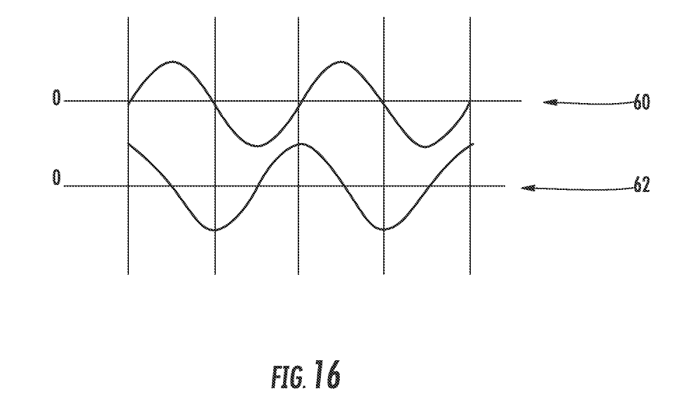

Another embodiment, the subject molecular dissociation apparatus and method employ a photon pulse emission system. When a photon strikes an electron, it excites the vibration of the electron, changing its interaction with other atoms. The higher the molecular density of the molecule, the more effective photonic disruption becomes. Referring to FIGS. 1 and 15, a parcel mirror 50 is mounted to first end 12A of reaction chamber 12 and solid reflective mirror 52 is mounted to the opposite end 12B of reaction chamber 12. Note that oscillating magnetic field generating assembly 22 has been removed solely for the purpose of illustrating photonic activity within the chamber. Parcel mirror 50 and solid mirror 52 are parallel to one another and have reflective surfaces 54 and 56, respectively, facing reaction space 16. A photon pulse emission system 26 is mounted to first end 12A of reaction chamber 12 with parcel mirror 50 disposed therebetween. Parcel mirror 50 permits the passage of a photon stream 58 generated by photon pulse emission system 26 into reaction space 16, but does not allow photons reflected by solid mirror 52 to pass in the opposite direction, instead reflecting the photon stream back into reaction space 16. Reflection of photons back and forth between parcel mirror 50 and solid mirror 52 boost the interaction between photons and the electrons of the target molecule.

The timing, intensity and frequency with which photons are emitted by photon pulse generation system 26 are regulated by controller 28. In operation, the emission of photon pulses and electromagnetic pulses generated by oscillating magnetic pulse generation assembly 22 do not coincide, but instead are emitted in alternating fashion. Referring to FIG. 16 it may be observed that the oscillating magnetic pulse wave 60 generated by oscillating magnetic field generation assembly 22 is offset from the photon pulses 62 generated by photon pulse generation system 26. When one system is emitting pulses the other is not and vice versa. Alternating the emissions of each system avoids bending of the photon stream which would otherwise result in the presence of a magnetic field. Bending of the stream would adversely affect its effectiveness. Additionally, by emitting pulses of photons rather than a steady stream of photons, the target molecule's electrons are more likely to remain within their own orbital fields, avoiding or reducing ionization of the target molecule.

Although the present invention has been described with reference to the particular embodiments herein set forth, it is understood that the present disclosure has been made only by way of example and that numerous changes in details of construction may be resorted to without departing from the spirit and scope of the invention. For example, the subject invention encompasses all methods and apparatus that employ frequency and vibration disruptions to separate atoms from their molecules, the heretofore described magnetic pulse oscillation and molecular photon pulse disruptor methods and apparatus being merely illustrative. Thus, the scope of the invention should not be limited by the foregoing specifications, but rather only by the scope of the claims appended hereto.

What is claimed as being new, useful and desired to be protected by Letters Patent of the United States is as follows:

1. A method of causing the dissociation of a target molecule into two or more other molecules, atoms, ions or radicals, the method comprising the steps of:
a. confining the target molecule within a reaction space of a reaction vessel;
b. subjecting the target molecule to an oscillating force substantially equal to and substantially in-phase with the resonant frequency of the target molecule;
whereby the wave amplitude of the electromagnetic force that binds the atoms of the molecule together reach the molecule's high energy threshold and dissociate.

2. A method of causing the dissociation of a target molecule into two or more other molecules, atoms, ions or radicals, the method comprising the steps of:
a confining the target molecule within a reaction space of a reaction vessel;
b. subjecting the target molecule to an oscillating force substantially equal to and substantially 180 degrees out-of-phase with the resonant frequency of the target molecule;
whereby the wave amplitude of the electromagnetic force that binds the atoms of the molecule together reach the molecule's low energy threshold and dissociate.

3. The method of claim 1 further comprising the step of subjecting the target molecule to a constant magnetic field in order to orient the target molecule along a predefined axis.

4. The method of claim 2 further comprising the step of subjecting the target molecule to a constant magnetic field in order to orient the target molecule along a predefined axis.

5. The method of claim 3 wherein said oscillating force is applied in the direction of said predefined axis.

6. The method of claim 4 wherein said oscillating force is applied in the direction of said predefined axis.

7. The method of claim 1 wherein said oscillating force is a magnetic force.

8. The method of claim 2 wherein said oscillating force is a magnetic force.

9. The method of claim 1 wherein said oscillating force is generated by an electromagnetic field.

10. The method of claim 2 wherein said oscillating force is generated by an electromagnetic field.

11. The method of claim 1 wherein said oscillating force is imparted on the target molecule from opposite directions.

12. The method of claim 2 wherein said oscillating force is imparted on the target molecule from opposite directions.

13. The method of claim 3 wherein said oscillating force is imparted on the target molecule from opposite directions.

14. The method of claim 4 wherein said oscillating force is imparted on the target molecule from opposite directions.

15. A molecular dissociation apparatus comprising:
a. a reaction chamber comprising a reaction vessel having a reaction space;
b. an oscillating electrical source;
c. an oscillating magnetic field generating assembly for imparting an oscillating force to a target molecule within said reaction space; said oscillating magnetic field generating assembly being operably connected to said oscillating electric source; said oscillating force being either substantially in-phase or substantially 180 degrees out-of-phase with the resonant frequency of a target molecule.

16. The molecular dissociation apparatus of claim 15 wherein said oscillating magnetic field generating assembly is comprised of at least one pair of electrical coils; each of said at least one pair of electrical coils having a first electrical coil on one side of said reaction chamber for imparting a first oscillating force on a target molecule and a second electrical coil on the opposite side of said chamber for imparting a second oscillating force on a target molecule.

17. The molecular dissociation apparatus of claim 16 further including means for firing said first electrical coil and said second electrical coil of each of said at least one pair of electrical coils in unison whereby said first oscillating force and said second oscillating force, respectively, are imparted to the target molecule in unison.

18. The molecular dissociation apparatus of claim 17 wherein the direction of said first oscillating force is normally axially aligned with the direction of said second oscillating force.

19. The molecular dissociation apparatus of claim 18 further comprising means for causing an axis of a target molecule to be axially aligned with the direction of said first oscillating force and said second oscillating force.

20. The molecular dissociation apparatus of claim 19 wherein said first oscillating force and said second oscillating force are directional opposites such that together they either stretch or compress the target molecule.
